(19) United States
(12) Patent Application Publication
(10) Pub. No.: US 2026/0223933 A1
(43) Pub. Date: Aug. 6, 2026

(54) INDUCTION HEATING MODULE FOR USE IN AN AEROSOL-GENERATING DEVICE

(71) Applicant: Philip Morris Products S.A., Neuchatel (CH)

(72) Inventors: Oleg MIRONOV, Cudrefin (CH); Farhang MOHSENI, Neuchâtel (CH)

(73) Assignee: Philip Morris Products S.A., Neuchatel (CH)

(21) Appl. No.: 19/152,705

(22) PCT Filed: Feb. 13, 2024
(86) PCT No.: PCT/EP2024/053622

§ 371 Date: Jul. 31, 2025

(30) Foreign Application Priority Data
Feb. 14, 2023 (EP) 23156477.4

(51) Int. Cl. A24F 40/465; A24D 1/00; A24D 1/20; A24F 40/10; A24F 40/20; A24F 40/30; H05B 6/10

(52) U.S. Cl. CPC A24F 40/465; A24D 1/002; A24D 1/20; A24F 40/10; A24F 40/20; A24F 40/30; H05B 6/108

(57) ABSTRACT

An induction heating module for alternative use with a first or a second inductively heatable aerosol-generating article is provided, the article being of a different type from the second article, the first article including a susceptor of a first type to heat a first aerosol-forming substrate contained in the first article, the second article including a susceptor of a second type to heat a second aerosol-forming substrate contained in the second article, the module including: a cavity to removably receive the first or the second article; an induction coil to generate an alternating magnetic field to inductively heat the respective susceptor of the first or the second article when being received in the cavity; and a magnetic flux concentrator arrangement including a flux concentrator transferable between first and second configurations such that the field is concentrated selectively in a first or a second region within the cavity.

The present disclosure relates to an induction heating module for an inductively heating aerosol-generating device that is configured for alternative use with at least two different types of inductively heatable aerosol-generating articles. The invention further relates to an aerosol-generating device comprising such an induction heating module. In addition, the invention relates to an aerosol-generating system comprising such a device and at least one aerosol-generating article of a first type and at least one aerosol-generating article of a second type.

Aerosol-generating devices using induction heating for generating inhalable aerosols are generally known from prior art. Such devices may comprise an induction coil for generating an alternating magnetic field used to induce at least one of heat generating eddy currents or hysteresis losses in a susceptor, which cause the latter to heat up. The susceptor in turn is arranged in thermal proximity or direct physical contact with an aerosol-forming substrate that is capable to form an inhalable aerosol upon heating. The susceptor and the substrate may be part of an aerosol-generating article that is receivable at least partially within a cavity of the device. The cavity and the induction coil may be part of an induction heating module, which may form one of several components that make up the device.

The heating process depends essentially on the field distribution of the alternating magnetic field in the cavity which ideally has to properly match the susceptor dimensions and the susceptor position in the cavity. For example, articles containing an elongate susceptor element embedded in a solid aerosol-forming substrate may require a correspondingly elongate field distribution. In contrast, articles with a compact susceptor in contact with a liquid aerosol-forming substrate that is to be aerosolized within a short time may require a reasonably strong field concentrated on the susceptor. As these two examples show, article-specific requirements for the magnetic field distribution can often differ significantly. For this reason, aerosol-generating devices using induction heating are usually designed for only one type of aerosol-generating article.

In general, it would be desirable to have an induction heating module and an inductively heating aerosol-generating device with the advantages of prior art solutions, whilst mitigating their limitations. In particular, it would be desirable to have an induction heating module and an inductively heating aerosol-generating device which are configured for alternative use with at least two different types of inductively heatable aerosol-generating articles.

According to an aspect of the present invention, there is provided an induction heating module for alternative use with at least a first inductively heatable aerosol-generating article and a second inductively heatable aerosol-generating article, that is, with at least a first type and a second type of inductively heatable aerosol-generating articles, wherein the first article (article of the first type) comprises a susceptor of a first type for heating a first aerosol-forming substrate contained in the first article, and the second article (article of the second type) comprises a susceptor of a second type for heating a second aerosol-forming substrate contained in the second article. The induction heating module comprises a cavity configured to removably receive at least a portion of the first or the second aerosol-generating article. The induction heating module further comprises an induction coil for generating an alternating magnetic field to inductively heat the respective susceptor of the first article or the second article when being received in the cavity. In addition, the induction heating module comprises a magnetic flux concentrator arrangement comprising a transferable flux concentrator which is transferable at least between a first configuration and a second configuration such that the alternating magnetic field of the induction coil is concentrated selectively in a first region or a second region within the cavity. The first region is associated with a dimension and/or a position of the susceptor of the first type in the cavity when the first article is received in the cavity. The second region is associated with a dimension and/or a position of the susceptor of the second type in the cavity when the second article is received in the cavity.

It may be that the transferable flux concentrator is transferable between the first configuration and the second configuration to modify the concentration of the alternating magnetic field of the induction coil between being concentrated in the first region within the cavity when the transferable flux concentrator is in the first configuration and being concentrated in the second region within the cavity when the transferable flux concentrator is in the second configuration. It may be that said modification of the concentration of the alternating magnetic field of the induction coil between being concentrated in the first region within the cavity and being concentrated in the second region within the cavity results from the transfer of the transferable flux concentrator between the first configuration and the second configuration without a change in the position of the induction coil relative to the cavity. It may be that said modification of the concentration of the alternating magnetic field of the induction coil between being concentrated in the first region within the cavity and being concentrated in the second region within the cavity results entirely from the transfer of the transferable flux concentrator between the first configuration and the second configuration.

As used herein, the terms “first aerosol-generating article” and “second aerosol-generating article” are to be understood as representative for two articles of different type or two different types of aerosol-generating articles, that is, an aerosol-generating article of a first type and an aerosol-generating article of a second type.

According to the invention it has been found that a universal induction heating module for alternative use with different types of inductively heatable articles may be easily realized by implementing a transferable flux concentrator that is capable of modifying the properties of the magnetic field generated by the induction coil within the cavity depending on which type of article is received in the cavity. Advantageously, the properties of the magnetic field may be modified such that the magnetic field is concentrated to a respective region within the cavity which is occupied by the respective susceptor of a specific article type when an article of the respective type is received in the cavity. As an example, where a first article (article of a first type) to be used with the induction heating module comprises a susceptor of a first type being a compact susceptor for heating a liquid aerosol-forming substrate, the transferable flux concentrator may be arranged in a first configuration such that the magnetic field generated by the induction coil is concentrated in a small first region where the susceptor of the first type is located during use, when the first article is received in the cavity. Due to the field concentration in a small region, the magnetic flux within the first region may be increased which especially allows to instantaneously heat the liquid substrate on a puff by puff basis (puff on demand). In contrast, where a second article (article of a second type) to be used with the heating module comprises, for example, a susceptor of a second type being an elongate, in particular strip-like susceptor element to be continuously heated, the transferable flux concentrator may be transferred into a second configuration (different from the first configuration) causing the magnetic field to be spread over a correspondingly elongate second region within the cavity (different from the first region) which matches the cavity position and dimension of the elongate susceptor of the second type when the second article (article of the second type) is received in the cavity.

Overall, the proposed transferable flux concentrator allows a single aerosol-generating device equipped with it to be used with a wider assortment of different aerosol-generating articles without having to use a separate device for each type of article.

As used herein, the terms “magnetic flux concentrator arrangement”, “transferable flux concentrator” and “stationary flux concentrator” (see below) each refer to an arrangement or a component including a material having a high relative magnetic permeability which acts to guide and concentrate the magnetic field or magnetic field lines generated by the induction coil. In this regard, the term “high relative magnetic permeability” refers to a relative magnetic permeability of at least 50 or 100, in particular of at least 1000, preferably of at least 10000, even more preferably of at least 50000, most preferably of at least 80000. These example values refer to the maximum values of relative magnetic permeability for frequencies up to 50 kHz and a temperature of 25 degrees Celsius. The term “relative magnetic permeability” refers to the ratio of the magnetic permeability of a material, or of a medium, such as the flux concentrator, to the magnetic permeability of free space μ_0, where μ_0 is 4 π·10⁻⁷ N·A⁻² (4·Pi·10E-07 Newton per square Ampere).

As used herein, the terms “transferable flux concentrator” and “flux concentrator is transferable between a first configuration and a second configuration” each may refer to different types of transferability. In particular, these terms may include “displacing the flux concentrator/flux concentrator is displaceable between a first position and a second position” or “changing a spatial shape of the flux concentrator/a spatial shape of the flux concentrator is changeable between a first configuration and a second configuration”. In this regard, “displaceable” may refer to a mechanical displacement, in particular a change of the position of the center-of-mass of the transferable flux concentrator. Likewise, “changing the spatial shape of the flux concentrator” may include a deformation of the transferable flux concentrator, such as a bending, an extension or a compression of the transferable flux concentrator, or a change of the spatial arrangement of a plurality of flux concentrator elements forming the transferable flux concentrator relative to each other.

As defined above, the first region is configured such that it matches at least one of a dimension of the susceptor of the first type and a cavity position of susceptor of the first type when the first article is received in the cavity. In particular, the first region may have a length extension along a length axis of the cavity that is similar to a length extension of the susceptor of the first type as measured in the same direction when received in the cavity. Likewise, the first region may have a lateral extension perpendicular to a length axis of the cavity that is similar to a lateral extension of the susceptor of the first type as measured in the same direction when received in the cavity. For example, the first region may have a length extension along a length axis of the cavity in a range between 2 millimeter and 7 millimeter, in particular between 3 millimeter and 5 millimeter. Likewise, the first region may have a lateral extension perpendicular to a length axis of the cavity in a range between 1 millimeter and 5 millimeter, in particular between 2 millimeter and 3 millimeter. Vice versa, the second region is configured such that it matches at least one of a dimension of the susceptor of the second type and a cavity position of the susceptor of the second type when the second article is received in the cavity. In particular, the second region may have a length extension along the length axis of the cavity that is similar to a length extension of the susceptor of the second type as measured in the same direction when received in the cavity. Likewise, the second region may have a lateral extension perpendicular to a length axis of the cavity that is similar to a lateral extension of the susceptor of the second type as measured in the same direction when received in the cavity. For example, the second region may have a length extension along a length axis of the cavity in a range between 4 millimeter and 12 millimeter, in particular between 5 millimeter and 8 millimeter. Likewise, the second region may have a lateral extension perpendicular to a length axis of the cavity in a range between 2 millimeter and 6 millimeter, in particular between 3 millimeter and 4 millimeter.

The transferable flux concentrator may be configured such that it is transferable from the first configuration to the second configuration and preferably also from the second configuration to or towards the first configuration by user interaction, in particular manually. For this, the magnetic flux concentrator arrangement may comprise a transfer mechanism, such as a slider or a pusher coupled to the transferable flux concentrator.

Preferably, the transferable flux concentrator is configured such that it is transferable from the first configuration to the second configuration by insertion of the second article (article of the second type) into the cavity. Advantageously, this enables to automatically adapt the device for use with a second article (article of the second type) without the user having to take any additional action. For this, the transferable flux concentrator may be configured and arranged to mechanically interact with the second article when being inserted into the cavity such as to be transferred from the first configuration to the second configuration. Details and examples of the mechanical interaction between the second article and the transferable flux concentrator will be described further below.

Furthermore, the transferable flux concentrator may be configured such that it is transferable from the second configuration to or towards the first configuration by removal of the second article from the cavity. Thus, the device is automatically (re-)adaptable/(re-)configurable for use with a first article (article of the first type), again without the user having to take any additional action.

The transfer of the transferable flux concentrator from the second configuration to or towards the first configuration may be accomplished in different ways.

The transferable flux concentrator may also be configured and arranged to mechanically interact with the second article when being removed from the cavity such as to be transferred from the second configuration towards or to the first configuration.

Alternatively or in addition, the magnetic flux concentrator arrangement may comprise a return mechanism configured and arranged to transfer the transferable flux concentrator from the second configuration towards or to the first configuration when the second article is removed from the cavity.

Preferably, the returning mechanism comprises at least one spring biasing the transferable flux concentrator towards or into the first configuration. As a result, the transferable flux concentrator is automatically returned from the second configuration towards or to the first configuration when the second article is removed from the cavity.

The spring may be attached to a distal end wall of the cavity. In this way, the distal end wall of the cavity may act as a backstop for the spring so that the spring can be compressed when the second article mechanically interact acts with the transferable flux concentrator when inserted into the cavity, for example through a proximal insertion opening of the cavity in the distal direction. As used herein, sections close to the insertion opening or close to a user's mouth in use, respectively, are denoted with the prefix “proximal”. Sections which are arranged further away are denoted with the prefix “distal”.

Where the transferable flux concentrator is displaced between the first and the second configuration, in particular between a first position and a second position, the trajectory of displacement may depend on the shape and configuration of the cavity. Where the cavity has a length axis, the transferable flux concentrator may be transferable in a movement along the length axis of the cavity between a first position corresponding to the first configuration and a second position corresponding to the second configuration. If the length axis of the article is a linear/straight, the deliverable flux concentrator may be transferable in a linear/straight movement (displaceable linearly or along a linear/straight trajectory) along the length axis of the cavity between a first position corresponding to the first configuration and a second position corresponding to the second configuration.

It may be that the induction coil is a stationary induction coil.

It may be that the induction coil is fixedly arranged relative to the cavity.

It may be that the transferable flux concentrator is movable relative to the induction coil. For example, where the transferable flux concentrator is transferable between the first configuration and the second configuration by being displaceable between the first position and the second position, it may be that the transferable flux concentrator is transferable between the first configuration and the second configuration by being displaceable relative to the induction coil between the first position and the second position. It may be that the transferable flux concentrator is transferable between the first configuration and the second configuration by being displaceable relative to the induction coil between the first position and the second position to thereby modify the concentration of the alternating magnetic field of the induction coil between being concentrated in the first region within the cavity when the transferable flux concentrator is in the first position and being concentrated in the second region within the cavity when the transferable flux concentrator is in the second position.

Where the transferable flux concentrator is inserted into the cavity in the distal direction and removed from the cavity into the proximal direction, for example through a proximal insertion opening of the cavity, the first position is more proximal and the second position is more distal with respect to the proximal insertion opening of the cavity.

The transferable flux concentrator may have any shape and structure allowing a transferability between the first configuration and the second configuration. In particular if displaceable, the transferable flux concentrator may comprise a solid flux concentrator body preferably a single solid flux concentrator body. Advantageously, a solid flux concentrator body is easy to manufacture. In addition, a solid flux concentrator body provides enhanced robustness, in particular if the transferable flux concentrator is configured to mechanically interact with the second article, for example, to get into contact with the second article.

As mentioned above, the terms “magnetic flux concentrator arrangement”, “transferable flux concentrator” and “stationary flux concentrator” (see below) as used herein each refer to an arrangement or a component including a material having a high relative magnetic permeability which acts to guide and concentrate the magnetic field or magnetic field lines generated by the induction coil. Accordingly, the transferable flux concentrator preferably comprises, in particular is made of a material or materials having a relative magnetic permeability of at least of at least 100, in particular of at least 1000, preferably of at least 10000, even more preferably of at least 50000, most preferably of at least 80000. These values preferably refer to maximum values of relative magnetic permeability at frequencies up to 50 kHz and a temperature of 25 degrees Celsius. In this regard, the transferable flux concentrator may comprise or may be made from any suitable material or combination of materials. Preferably, the transferable flux concentrator, in particular the solid flux concentrator body of the transferable flux concentrator, comprises a ferrimagnetic or ferromagnetic material, for example ferrimagnetic or ferromagnetic particles or a ferrimagnetic or ferromagnetic powder held a ferrite material, such as ferrite particles or a ferrite powder held in a matrix, or any other suitable material including ferromagnetic material such as iron, ferromagnetic steel, iron-silicon or ferromagnetic stainless steel. The matrix may comprise a binder, for example a polymer, such as a silicone. Accordingly, the matrix may be a polymer matrix, such as a silicone matrix. The ferromagnetic material may comprise at least one metal selected from iron, nickel and cobalt and combinations thereof, and may contain other elements, such as chromium, copper, molybdenum, manganese, aluminum, titanium, vanadium, tungsten, tantalum, silicon. The ferromagnetic material may comprise from about 78 weight percent to about 82 weight percent nickel, between 0 and 7 weight percent molybdenum and the reminder iron. As an example transferable flux concentrator, in particular the solid flux concentrator body of the transferable flux concentrator, may comprise or be made of a permalloy. Permalloys are nickel-iron magnetic alloys, which typically contain additional elements such as molybdenum, copper and/or chromium. As another example, the transferable flux concentrator, in particular the solid flux concentrator body of the transferable flux concentrator, may comprise or be made of a mu-metal. A mu-metal is a nickel-iron soft ferromagnetic alloy with very high magnetic permeability, in particular of about 80000 to 100000. For example, the mu-metal may comprise approximately 77 weight percent nickel, 16 weight percent iron, 5 weight percent copper, and 2 weight percent chromium or molybdenum. Likewise, the mu-metal may comprise 80 weight percent nickel, 5 weight percent molybdenum, small amounts of various other elements, such as silicon, and the remaining 12 to 15 weight percent iron.

Materials having a high relative magnetic permeability often are brittle and thus can easily break into fragments when exposed to excessive force impacts as a consequence, the integrity of the magnetic flux concentrator may be lost causing the magnetic flux through the shattered flux concentrator to be reduced. As a remedy, the transferable flux concentrator, in particular the solid flux concentrator body of the transferable flux concentrator, may be coated at least partially by a bond layer. Advantageously, the bond layer may serve as a support layer fixedly coupled to at least a portion of the transferable flux concentrator (solid flux concentrator body of the transferable flux concentrator). Due to the fixed coupling, the bond layer keeps possible fragments of the transferable flux concentrator bonded, that is, in position in the event of breakage into fragments. To this extend, it has been found that the effect of the transferable flux concentrator may be still sufficient if the fragments of the transferable flux concentrator are close together such as to be still capable to effectively concentrator the magnetic flux. In addition to the bonding function, the bond layer may also have shock-absorbing properties. Advantageously, this may even allow for preventing the transferable flux concentrator from breakage and thus to protect the integrity of the transferable flux concentrator in case of excessive force impacts.

The bond layer may be fixedly coupled to at least a portion of the transferable flux concentrator by at least one of the following means or processes: gluing, cladding, welding, plating, depositing, and coating, in particular dip coating or roll coating or evaporation coating.

Preferably, the bond layer is a coating covering at least a portion of a surface of the transferable flux concentrator. Advantageously, the coating may be easily applied after manufacturing of the deliverable flux concentrator but prior to assemblage of the induction heating module. The coating process beneficially results in a uniform bond across a large portion of the surface of the transferable flux concentrator or even the entire surface.

The bond layer may have a layer thickness in a range between 0.1 micrometer and 200 micrometer, in particular between 0.2 micrometer and 150 micrometer, preferably between 0.5 micrometer and 100 micrometer. Alternatively, the bond layer may have a layer thickness in a range between 0.5 micrometer and 200 micrometer. Advantageously, such layer thicknesses substantially do not affect the outer dimensions of the transferable flux concentrator.

Preferably, the bond layer is a polymeric bond layer. Polymeric bond layers prove beneficial as being flexible and thus shock-proof. In addition, polymeric bond layers may allow for a simple processing. The bond layer may comprise or consist of a poly(p-xylylene) polymer, in particular a chemical vapor deposited poly(p-xylylene) polymer. For example, the bond layer may comprise or consist of a parylene, for example, one of parylene C, parylene N, parylene D or parylene HT. The term “parylene” denotes a group of poly(p-xylylene) polymers, in particular chemical vapor deposited poly(p-xylylene) polymers, often used as moisture and dielectric barriers. Parylenes are biostable and biocompatible, and approved for medical application (FDA [Food and Drug Administration)] certified). Parylenes are optically transparent, flexible and chemically inert, thus providing a high corrosion protection. Parylenes are thermally stable, having a melting point above 290 degree Celsius or even higher, depending on the specific parylene type. This makes parylenes particularly suitable for use in inductively heating aerosol-generating systems. Advantageously, parylenes may be applied as thin-films or coatings, in particular to a large variety of substrates, such as metals, glass, varnish, plastic materials, ferrite materials or silicones. Preferably, parylene coatings may be applied to the substrate under vacuum, in particular at room temperature (for example 20 degree Celsius) by re-sublimation from the gas phase as a pore-free and transparent polymer film. This process may provide a uniform layer formation which is mechanically stable, abrasion resistant, and which produces low mechanical stresses and does not show outgassing. In addition, evaporation coating under vacuum allows for coating a plurality of substrates simultaneously, making the process suitable for mass production.

In addition to the transferable flux concentrator, the magnetic flux concentrator arrangement may comprise a stationary flux concentrator. Preferably, the stationary flux concentrator is arranged and configured to have an overall concentrating function, in particular to conduct the alternating magnetic field generated by the induction coil towards interior space of the cavity as a whole.

For this, the stationary flux concentrator preferably is arranged around at least a portion of the cavity. Likewise, the stationary flux concentrator may be arranged around at least a portion of the induction coil, in particular around at least a portion of a periphery of the induction coil, especially where the induction coil is arranged around at least a portion of the cavity, in particular around at least a portion of a periphery of the cavity. In this configuration, the stationary flux concentrator can most effectively conduct and concentrate the alternating magnetic field into the interior space of the cavity. In addition, an arrangement of the stationary flux concentrator around at least a portion of the induction coil advantageously reduces the extent to which the magnetic field propagates beyond the induction coil. That is, the stationary flux concentrator also acts as a magnetic shield. This may reduce undesired heating of adjacent susceptive parts of the induction heating module or of the aerosol-generating device the module is to be used in, for example a metallic outer housing. This configuration also facilitates to reduce undesired heating of adjacent susceptive items external to the induction heating module or the aerosol-generating device the module is to be used in. Overall, by reducing undesired heating losses, the efficiency of the induction heating module may be further improved.

In general, the stationary flux concentrator may have any shape, yet preferably a shape matching the shape of the induction coil and/or the cavity which the stationary flux concentrator preferably is arranged around at least partially. For example, the stationary flux concentrator may have a substantially cylindrical shape, in particular a sleeve shape or a tubular shape. That is, the stationary flux concentrator may be a tubular stationary flux concentrator or a stationary flux concentrator sleeve or a cylindrical stationary flux concentrator. Such shapes are particularly suitable in case the induction coil has a substantially cylindrical shape, especially in case the induction coil is a helical induction coil having a substantially cylindrical shape. Likewise, a tubular, sleeve or cylindrical shape also proves advantageous with regard to a cylindrical shape of the cavity.

In this regard, it is to be mentioned that the induction coil may have a substantially cylindrical shape. In particular, the induction coil may be a cylindrical-helical coil. Likewise, the cavity may have a substantially cylindrical shape. Preferably, the induction coil has an axial length extension that is similar to an axial length extension of at least one of the susceptor of the first type and the susceptor of the second type as measured in the same direction when received in the interior space of the induction coil. For example, the induction coil may have an axial length in a range between 4 millimeter and 12 millimeter, in particular between 5 millimeter and 8 millimeter.

In the configurations described above, the stationary flux concentrator may completely circumscribe the induction coil and/or the cavity along at least a part of the axial length extension of the induction coil and/or the cavity. As seen in a plane perpendicular to the actual length extension of the induction coil and/or the cavity, the flux concentrator may have any suitable cross-section. For example, the flux concentrator may have a square, oval, rectangular, triangular, pentagonal, hexagonal, or similar cross-sectional shape. Preferably, the flux concentrator has a circular cross-section. For example, the flux concentrator may have a circular, cylindrical shape.

It is also possible that the stationary flux concentrator extends only partially around the periphery of the induction coil and/or the cavity in the circumferential direction.

In any of the aforementioned configurations, the stationary flux concentrator may be arranged coaxially with a center line of the induction coil and/or a center line of the cavity.

Advantageously, the stationary flux concentrator may comprise, especially may be made of a flux concentrator foil. Using flux concentrator foils proves advantageous due to their flexible nature which provides good shock absorption properties and, thus, can withstand higher excessive force impacts or shocks without breakage. In addition flux concentrator foils allow for more compact design of the induction heating module due to their small dimensions (small thickness). Usage of a flux concentrator foil also allows for compensating manufacturing tolerances as well as for fine tuning of the inductance. In this regard, usage of the flux concentrator foil may advantageously help to enhance the impedance stability of the induction coil with temperature. As used herein, the term “foil” refers to a thin sheet material having a thickness much smaller than the dimension in any direction perpendicular to the direction of the thickness, wherein the term “thickness” refers to the dimension of the foil perpendicular to the main surfaces of the foil. Preferably, the flux concentrator foil may have a thickness in a range between 0.02 millimeter and 0.25 millimeter, in particular between 0.05 millimeter and 0.2 millimeter, preferably between 0.1 millimeter and 0.15 millimeter or between 0.04 millimeter and 0.08 millimeter or between 0.03 millimeter and 0.07 millimeter. Such values allow for a particularly compact design of the aerosol-generating device. Yet, these values are still large enough to sufficiently conduct and concentrate the alternating magnetic field in the cavity.

Similar to the transferable flux concentrator, the stationary flux concentrator, in particular the flux concentrator foil, preferably comprises or is made of a material or materials having a relative magnetic permeability of at least of at least 100, in particular of at least 1000, preferably of at least 10000, even more preferably of at least 50000, most preferably of at least 80000. These values preferably refer to maximum values of relative magnetic permeability at frequencies up to 50 kHz and a temperature of 25 degrees Celsius. In particular, the stationary flux concentrator or the flux concentrator foil may comprise or may be made of one of the materials disclosed further above with regard to the transferable flux concentrator. Preferably, the stationary flux concentrator or the flux concentrator foil comprises or is made of at least one of a permalloy or a nano-crystalline soft magnetic alloy. As an example, the stationary flux concentrator or the flux concentrator foil may comprise or may be made of an alloy available under the trademark Nanoperm® from MAGNETEC GmbH, Germany. Nanoperm® alloys are iron-based nano-crystalline soft magnetic alloys comprising from about 83 weight percent to about 89 weight percent iron. As used herein, the term “nano-crystalline” refers to a material having a grain size of about 5 nanometers to 50 nanometers. As another example, the stationary flux concentrator or the flux concentrator foil may comprise or may be made of an alloy available under the trademark Vitroperm® or Vitrovac® from VACUUMSCHMELZE GmbH & Co. KG, Germany. Vitrovac® alloys are amorphous (metallic glasses), whereas Vitroperm® alloys are nano-crystalline soft magnetic alloys. For example, the transferable flux concentrator may comprise or be made of Vitroperm 220, Vitroperm 250, Vitroperm 270, Vitroperm 400, Vitroperm 500 or Vitroperm 800. As yet another example, the stationary flux concentrator or the flux concentrator foil may comprise or may be made of a brazing foil available under the trademark Metglas® from Metglas®, Inc. USA or from Hitachi Metals Europe GmbH, Germany. Metglas® brazing foils are amorphous nickel based brazing foils.

In general, the flux concentrator foil may be either a single-layer flux concentrator foil or a multi-layer flux concentrator foil. For example, the multi-layer flux concentrator foil may comprise a substrate layer film and at least one layer of a ferromagnetic material disposed upon the substrate layer. According to another example, the multi-layer flux concentrator foil may comprise a multi-layer stack comprising one or more pairs of layers, each pair comprising a spacing layer and a layer of a ferromagnetic material disposed upon the spacing layer. According to yet another example, the multi-layer flux concentrator foil may comprise a substrate layer and a multi-layer stack disposed upon the substrate layer, wherein the multi-layer stack comprises one or more pairs of layers, each pair comprising a spacing layer and a layer of a ferromagnetic material disposed upon the spacing layer. in addition, the multi-layer flux concentrator foil may comprise at least one of a protective layer (for example made of polymers or ceramics) or an adhesive layer, which preferably form at least one of the two outer most layers (edge layers) of the multi-layer flux concentrator foil.

The flux concentrator foil may be wrapped around the periphery of the induction coil and or the cavity, in particular in one or more turns.

Furthermore, the induction heating module may comprise a radial gap between the induction coil/cavity and the stationary flux concentrator at least partially surrounding the induction coil/cavity. The gap may be an air gap or a gap filled with a filler material, for example a polyimide, such as poly(4,4′-oxydiphenylene-pyromellitimide), also known as Kapton®, or any other suitable dielectric materials. The gap may have a radial extension in a range between 40 micrometer and 400 micrometer, in particular between 100 micrometer and 240 micrometer, for example 220 micrometer. Advantageously, the gap may help to reduce losses in the induction coil and to increase losses in the susceptor to be heated, that is, to increase the heating efficiency of the aerosol-generating device.

The induction heating module may comprise an electrically conductive shielding, in particular an electrically conductive shielding wrapper, which is arranged around the stationary flux concentrator. Advantageously, the electrically conductive shielding serves to shield the environment of the induction heating module from the magnetic field within the module.

The induction heating module may further comprise a coil support for supporting the induction coil. The coil support may be arrangeable within the device housing of an aerosol-generating device, the induction heating module is to be used with. In particular, the coil support may comprise a sleeve portion the interior space of which preferably defines the cavity for receiving the first and the second articles.

The present disclosure further relates to an aerosol-generating device for alternative use with at least a first inductively heatable aerosol-generating article (inductively heatable aerosol-generating article of a first type) and a second inductively heatable aerosol-generating article (inductively heatable aerosol-generating article of a second), wherein the first article comprises a susceptor of a first type for heating a first aerosol-forming substrate contained in the first article, and the second article comprises a susceptor of a second type for heating a second aerosol-forming substrate contained in the second article. The aerosol-generating device comprises an induction heating module according to the present invention and as described herein. Preferably, at least one of the first article and the second article is a first article and a second article according to the present invention and as described in, respectively.

As used herein, the term “aerosol-generating device” is used to describe an electrically operated device that is capable of interacting alternatively with one of the first and the second article such as to generate an aerosol by inductively heating the first or the second substrate via interaction of the respective susceptor with the alternating magnetic field provided by the device. Preferably, the aerosol-generating device is a puffing device for generating an aerosol that is directly inhalable by a user through the user's mouth. In particular, the aerosol-generating device is a hand-held aerosol-generating device.

The aerosol-generating device may comprise a device housing which the induction heating module is located or arranged in.

The aerosol-generating device, in particular the device housing may be configured such the interior space of the cavity of the induction heating module is freely accessible from outside the device in order to enable insertion of a first or a second aerosol-generating article therein.

The aerosol-generating device may further comprise an alternating current (AC) generator. The AC generator is operatively coupled to the induction coil. In particular, the induction coil may be integral part of the AC generator. The AC generator is configured to generate a high frequency oscillating current to be passed through the induction coil for generating an alternating magnetic field. The AC current may be supplied to the induction coil continuously following activation of the system or may be supplied intermittently, such as on a puff by puff basis.

The aerosol-generating device may comprise a power supply, in particular a DC power supply, configured to provide a (DC) supply voltage and a (DC) supply current for powering operation of the device, in particular for powering the AC generator. Preferably, the power supply is a battery such as a lithium iron phosphate battery. The power supply may have sufficient capacity to allow for the continuous generation of aerosol for a period of around six minutes or for a period that is a multiple of six minutes. Likewise, the power supply may have sufficient capacity to allow for a predetermined number of puffs or discrete activations of the inductive heating module.

Where the power supply is a DC power supply, the aerosol-generating device, in particular the AC generator, may comprise a DC/AC converter connected to the DC power in order to provide an AC current to be passed through the induction coil. The DC/AC converter may comprise a power amplifier, in particular a switching power amplifier, more particularly a single-ended switching power amplifier, preferably one of a Class-C power amplifier or a Class-D power amplifier or Class-E power amplifier.

The aerosol-generating device preferably is configured to generate a high-frequency varying magnetic field. As referred to herein, the high-frequency varying magnetic field may have a frequency in a range between 500 kHz to 30 MHz, in particular between 5 MHz to 15 MHz, preferably between 5 MHz and 10 MHz.

The aerosol-generating device may further comprise a controller configured to control operation of the device. In particular, the controller may be configured to control heating of the aerosol-forming substrate to a pre-determined operating temperature in particular to different predetermined operating temperatures associated to each one of the first and the second article.

The aerosol-generating device may further comprise a puff detector, such as a microphone or a pressure sensor, for detecting a user's puff, that is, the onset of a user experience when a user starts puffing on the device. The puff detector may be operatively connected to the controller. By this, the detection of the occurrence of a puff by means of the puff detector may trigger the power delivery to the induction coil for generating an aerosol. That is, the controller may be configured to start operation of the heating arrangement, in particular generation of an alternating magnetic field in response to the puff detector detecting the occurrence of a user's puff.

Further features and advantages of the aerosol-generating device have already been described with regard to the induction heating module of the present invention, and equally apply.

The present disclosure further relates to a first inductively heatable aerosol-generating article (inductively heatable aerosol-generating article of a first type) for use with an induction heating module according to the present invention or within aerosol-generating device according to the present invention. The first article comprises a susceptor of a first type and is configured such that the transferable flux concentrator of the induction heating module is, preferably remains, in the first configuration upon insertion of the first article into the cavity.

For this, the first article preferably is configured such that the transferable flux concentrator and the first article do not interact mechanically with each other during insertion of the first article or during at least a section, in particular a major section of an insertion movement or an insertion path of the first article within the cavity.

As an example, the first article may comprise at least one recess, in particular at least one distal recess for receiving the transferable flux concentrator or at least parts of the transferable flux concentrator therein, such that the transferable flux concentrator is, preferably remains, in the first configuration upon insertion of the first article into the cavity. The at least one distal recess may be configured such that the transferable flux concentrator or at least parts of the transferable flux concentrator received therein do not interact mechanically with the first article during at least a section, in particular a major section of an insertion movement or an insertion path of the first article within the cavity. In a pre-defined (final) position of the first article in the cavity or when the first article has reached or is about to reach a pre-defined (final) position in the cavity, the transferable flux concentrator may interact mechanically with the first article. In this position of the first article, the transferable flux concentrator may be contact with, in particular may abut against a surface of the first article, in particular a surface of the at least one recess, such as a bottom surface of the at least one recess.

The first article may be configured to provide an aerosol from a liquid aerosol-forming substrate. Accordingly, the first article may comprise a liquid reservoir for storing a liquid aerosol-forming substrate therein. The liquid reservoir may be a refillable liquid reservoir. The liquid reservoir may contain a liquid aerosol-forming substrate (being the first aerosol-forming substrate).

In particular, where the first aerosol-forming substrate is a liquid aerosol-forming substrate, the susceptor of the first type may comprise or may be a mesh susceptor, a filament susceptor or a wick susceptor. In any of these configurations, the susceptor advantageously is capable to perform both functions: wicking (conveying) and heating the aerosol-forming liquid. Accordingly any of the aforementioned configurations, the susceptor may be considered a liquid-conveying susceptor. in any of these configurations, the susceptor of the first type preferably is in fluid communication with the liquid reservoir in which the aerosol-forming liquid is storable/stored. Alternatively or in addition to a liquid-conveying susceptor, the article of the first time may comprise a liquid-conveying element, such as a wick, which provides a fluid communication for the first liquid aerosol-forming substrate from the liquid reservoir to the susceptor of the first type.

It is also possible that the susceptor of the first type may comprise or may be susceptor sleeve, a susceptor cup, a cylindrical susceptor, a tubular susceptor, a susceptor blade, a susceptor strip or a susceptor plate.

The susceptor of the first type preferably matches the dimensions of the first region in the cavity of the induction heating module into which the alternating magnetic field of the induction coil is concentrated when the transferable flux concentrator is in the first configuration. For example, the susceptor of the first type may have a length extension in a range between 2 millimeter and 7 millimeter, in particular between 3 millimeter and 5 millimeter, as measured in the direction along a length axis of the cavity when the first article is received in the cavity. Likewise, the susceptor of the first type may have a lateral extension in a range between 1 millimeter and 5 millimeter, in particular between 2 millimeter and 3 millimeter, as measured in a direction perpendicular to the length axis of the cavity when the first article is received in the cavity.

Further features and advantages of the first article (inductively heatable aerosol-generating article of the first type) have already been described with regard to the induction heating module of the present invention, and equally apply.

The present disclosure further relates to a second inductively heatable aerosol-generating article (inductively heatable aerosol-generating article of the second type) for use with an induction heating module according to the present invention or within aerosol-generating device according to the present invention. The second article comprises a susceptor of a second type and preferably is configured such as to interact mechanically with the transferable flux concentrator or at least parts thereof when the second article is inserted into the cavity, thereby transferring the transferable flux concentrator from the first configuration into the second configuration.

For this, the second article may comprise a contact surface at a distal end of the article configured to contact the transferable flux concentrator or at least parts of the transferable flux concentrator when inserting the second article into the cavity, thus enabling to transfer the transferable flux concentrator from the first configuration into the second configuration when further inserting the second article into the cavity. For example, as mentioned, it may be that the transferable flux concentrator is transferable between the first configuration and the second configuration by being displaceable (e.g., relative to the induction coil) between the first position and the second position. In this case, it may be that the second article comprises a contact surface at a distal end of the article configured to contact the transferable flux concentrator or at least parts of the transferable flux concentrator when inserting the second article into the cavity, thus enabling to displace the transferable flux concentrator (e.g., relative to the induction coil) from the first position into the second position when further inserting the second article into the cavity.

The second article may be configured to provide an aerosol from a solid or gel-like aerosol-forming substrate (being the second aerosol-forming substrate). Accordingly, the second article may comprise a second aerosol-forming substrate which is a solid aerosol-forming substrate (being the second aerosol-forming substrate).

The susceptor of the second type may be an elongate susceptor. The susceptor of the second type may be a flat susceptor or a sheet-like susceptor, in particular an elongate flat susceptor or an elongate sheet-like susceptor. The flat or sheet-like susceptor may comprise or may be a susceptor blade, a susceptor strip or a susceptor plate, in particular an elongate susceptor blade, an elongate susceptor strip or an elongate susceptor plate.

As already described above with respect to the susceptor of the first type, the susceptor of the second type preferably matches the dimensions of the second region in the cavity of the induction heating module into which the alternating magnetic field of the induction coil is concentrated when the transferable flux concentrator is in the second configuration. For example, the susceptor of the first type may have a length extension in a range between 4 millimeter and 12 millimeter, in particular between 5 millimeter and 8 millimeter as measured in the direction along a length axis of the cavity when the second article is received in the cavity. Likewise, the susceptor of the second type may have a lateral extension in a range between 2 millimeter and 6 millimeter, in particular between 3 millimeter and 4 millimeter, as measured in a direction perpendicular to a length axis of the cavity when the second article is received in the cavity.

Preferably, the susceptor of the second type is arranged in thermal contact with or thermal proximity to the second aerosol-forming substrate. In particular, the susceptor of the second type may be embedded in the second aerosol-forming substrate.

Further features and advantages of the second article (inductively heatable aerosol-generating article of the second type) have already been described with regard to the induction heating module of the present invention, and equally apply.

As used in, the terms “first aerosol-generating article/aerosol-generating article of the first type” and “second aerosol-generating article/aerosol-generating article of the second type” refer to an article comprising or being capable of storing/containing at least one aerosol-forming substrate that, when heated, releases volatile compounds that can form an aerosol. The aerosol-generating article of the first and/or the second type may be a consumable, in particular a consumable to be discarded after a single use.

As used herein, the term “susceptor” refers to an element that is capable to convert electromagnetic energy into heat when subjected to a varying magnetic field. This may be the result of at least one of hysteresis losses or eddy currents which are induced in the susceptor, depending on the electrical and magnetic properties of the susceptor material. Hysteresis losses occur in ferromagnetic or ferrimagnetic susceptors due to magnetic domains within the susceptor material being switched under the influence of a varying magnetic field. Eddy currents may be induced if the susceptor is electrically conductive. In case of an electrically conductive ferromagnetic or ferrimagnetic susceptor, heat can be generated due to both, eddy currents and hysteresis losses. Accordingly, the susceptor of the first type and the susceptor of the second type may be formed from any material that can be inductively heated to a temperature sufficient to generate an aerosol from the respective aerosol-forming substrate. A preferred susceptor of the first type or the second type may comprise a ferromagnetic material, for example ferritic iron, or a ferromagnetic steel or stainless steel. A suitable susceptor may be, or comprise, aluminum. Preferred susceptors may be formed from 400 series stainless steels, for example grade 410, or grade 420, or grade 430 stainless steel.

In general, the first and the second aerosol-forming substrate may be formed from or comprising an aerosol-forming material that is capable of releasing volatile compounds upon heating in order to generate an aerosol. The first and the second aerosol-forming substrate preferably intended to be heated rather than combusted to release the aerosol-forming volatile compounds. The first and second aerosol-forming substrate may be a solid aerosol-forming substrate, a liquid aerosol-forming substrate, a gel-like aerosol-forming substrate, or any combination thereof. As mentioned above, the first aerosol-forming substrate preferably is a liquid aerosol-forming substrate, that is an aerosol-forming liquid. The aerosol-forming liquid may contain both, solid and liquid aerosol-forming material or components. The aerosol-forming liquid may be a water-based aerosol-forming liquid or an oil-based aerosol-forming liquid. Likewise, the second aerosol-forming substrate preferably is a solid aerosol-forming substrate or a gel-like aerosol-forming substrate, or a combination thereof. The first and the second aerosol-forming substrate may comprise a tobacco-containing material containing volatile tobacco flavor compounds, which are released from the substrate upon heating. Alternatively or additionally, the first and the second aerosol-forming substrate may comprise a non-tobacco material. The first and the second aerosol-forming substrate may further comprise an aerosol former. Examples of suitable aerosol formers are glycerin and propylene glycol. The first and the second aerosol-forming substrate, in particular the aerosol-forming liquid may also comprise other additives and ingredients, such as nicotine or flavourants. In particular, the aerosol-forming liquid may include water, solvents, ethanol, plant extracts and natural or artificial flavors.

According to another aspect of the present invention, there is provided an aerosol-generating system comprising an aerosol-generating device according to the present invention and as described in, as well as at least one first inductively heatable aerosol-generating article (article of the first type), in particular at least one first inductively heatable aerosol-generating article (article of the first type) according to the present invention and as described herein, and at least one second inductively heatable aerosol-generating article (article of the second type), in particular at least one second inductively heatable aerosol-generating article (article of the second type) according to the present invention and as described in.

In particular, the first article may comprise a susceptor of a first type for heating a first aerosol-forming substrate contained in the first article, and the second article may comprise a susceptor of a second type for heating a second aerosol-forming substrate contained in the second article.

As described above with regard to the first article, the transferable flux concentrator and the first article may be configured such that the transferable flux concentrator is, preferably remains, in the first configuration upon insertion of the first article into the cavity. Likewise, the transferable flux concentrator and the first article may be configured such that the transferable flux concentrator and the first article do not interact mechanically with each other when the first article is inserted into the cavity. For this, the first article may comprise at least one recess, in particular at least one distal recess for receiving the transferable flux concentrator or at least parts of the transferable flux concentrator therein, such that the transferable flux concentrator is, preferably remains, in the first configuration upon insertion of the first article into the cavity. For further details of the mutual configuration of the transferable flux concentrator and the first article reference is made to the above description of the induction heating module and the first article according to the present invention.

As also mentioned further above, the first article preferably comprises a liquid reservoir containing a liquid aerosol-forming substrate.

In contrast to the first article, the second article preferably is configured such as to interact mechanically with the transferable flux concentrator or at least parts thereof when the second article is inserted into the cavity, thereby transferring the transferable flux concentrator from the first configuration into the second configuration. For this, the second article may comprise a contact surface at a distal end of the article configured to contact the transferable flux concentrator or at least parts of the transferable flux concentrator when inserting the second article into the cavity, thus enabling to transfer the transferable flux concentrator from the first configuration into the second configuration when further inserting the second article into the cavity. For example, as mentioned, it may be that the transferable flux concentrator is transferable between the first configuration and the second configuration by being displaceable (e.g., relative to the induction coil) between the first position and the second position. In this case, it may be that the second article comprises a contact surface at a distal end of the article configured to contact the transferable flux concentrator or at least parts of the transferable flux concentrator when inserting the second article into the cavity, thus enabling to displace the transferable flux concentrator (e.g., relative to the induction coil) from the first position into the second position when further inserting the second article into the cavity. Further details of the mutual configuration of the transferable flux concentrator and the second article have already been described above with respect to the induction heating module and the first article. To avoid unnecessary repetition, reference is made to the respective description.

As mentioned, the second article preferably comprises a solid aerosol-forming substrate.

Further features and advantages of the aerosol-generating system have already been described with regard to the induction heating module, the aerosol-generating device, the first article and the second article of the present invention, and equally apply.

The invention is defined in the claims. However, below there is provided a non-exhaustive list of non-limiting examples. Any one or more of the features of these examples may be combined with any one or more features of another example, embodiment, or aspect described herein.
Example Ex1: An induction heating module for alternative use with at least a first inductively heatable aerosol-generating article and a second inductively heatable aerosol-generating article, the first article comprising a susceptor of a first type for heating a first aerosol-forming substrate contained in the first article, the second article comprising a susceptor of a second type for heating a second aerosol-forming substrate contained in the second article, the induction heating module comprising:
a cavity configured to removably receive at least a portion of the first or the second article;
an induction coil for generating an alternating magnetic field to inductively heat the respective susceptor of the first article or the second article when being received in the cavity;
a magnetic flux concentrator arrangement comprising a flux concentrator which is transferable at least between a first configuration and a second configuration such that the alternating magnetic field of the induction coil is concentrated selectively in a first region or a second region within the cavity, wherein the first region is associated with a dimension and/or a position of the susceptor of the first type in the cavity when the first article is received in the cavity, and wherein the second region is associated with a dimension and/or a position of the susceptor of the second type in the cavity when the second article is received in the cavity.
Example Ex2: The induction heating module according to examples Ex1, wherein the transferable flux concentrator is transferable from the first configuration to the second configuration by insertion of the second article.
Example Ex3: The induction heating module according to any one of the preceding examples, wherein the transferable flux concentrator is configured and arranged to mechanically interact with the second article when being inserted into the cavity such as to be transferred from the first configuration to the second configuration.
Example Ex4: The induction heating module according to any one of the preceding examples, wherein the transferable flux concentrator is transferable from the second configuration to or towards the first configuration by removal of the second article from the cavity.
Example Ex5: The induction heating module according to any one of the preceding examples, wherein the transferable flux concentrator is configured and arranged to mechanically interact with the second article when being removed from the cavity such as to be transferred from the second configuration to or towards the first configuration.
Example Ex6: The induction heating module according to any one of the preceding examples, wherein the magnetic flux concentrator arrangement comprises a return mechanism configured and arranged to transfer the transferable flux concentrator from the second configuration towards or to the first configuration when the second article is removed from the cavity.
Example Ex7: The induction heating module according to example Ex6, wherein the returning mechanism comprises at least one spring biasing the transferable flux concentrator towards or into the first configuration.
Example Ex8: The induction heating module according to example Ex7, wherein the spring is attached to a distal end wall of the cavity.
Example Ex9: The induction heating module according to any one of the preceding examples, wherein the transferable flux concentrator is transferable between the first and the second configuration in a movement, in particular a linear movement, along a length axis of the cavity, between a first position corresponding to the first configuration and a second position corresponding to the second configuration.
Example Ex10: The induction heating module according to any one of the preceding examples, wherein the first position is more proximal and the second position is more distal with respect to a proximal insertion opening of the cavity.
Example Ex11: The induction heating module according to any one of the preceding examples, wherein the transferable flux concentrator comprises a solid flux concentrator body.
Example Ex12: The induction heating module according to any one of the preceding examples, wherein the transferable flux concentrator comprises a ferromagnetic material, for example a ferrite material, a ferrite powder, held in a binder, or ferromagnetic steel, in particular ferromagnetic stainless steel.
Example Ex13: The induction heating module according to any one of the preceding examples, wherein the transferable flux concentrator is coated at least partially by a bond layer.
Example Ex14: The induction heating module according to any one of the preceding examples, wherein the bond layer comprises or consists of a poly(p-xylylene) polymer.
Example Ex15: The induction heating module according to any one of the preceding examples, wherein the magnetic flux concentrator arrangement comprises a stationary flux concentrator.
Example Ex16: The induction heating module according to any one of the preceding examples, wherein the stationary flux concentrator is arranged around the induction coil.
Example Ex17: The induction heating module according to any one of the preceding examples, wherein the stationary flux concentrator comprises a flux concentrator foil, in particular a multi-layer flux concentrator foil.
Example Ex18: The induction heating module according to example Ex17, wherein the flux concentrator foil comprises at least one of a permalloy or a nano-crystalline soft magnetic alloy.
Example Ex19: The induction heating module according to any one of the preceding examples, wherein the induction coil has a substantially cylindrical shape.
Example Ex20: The induction heating module according to any one of the preceding examples, wherein the induction coil is a cylindrical-helical coil.
Example Ex21: The induction heating module according to any one of the preceding examples, wherein the induction coil is arranged around at least a portion of the receiving cavity.
Example Ex22: The induction heating module according to any one of the preceding examples, wherein the cavity has a substantially cylindrical shape.
Example Ex23: A first inductively heatable aerosol-generating article for use with an induction heating module according to any one of the preceding examples or with an induction heating module according to any one of examples Ex37 to Ex43, the first article comprising a susceptor of a first type and being configured such that the transferable flux concentrator is, preferably remains, in the first configuration upon insertion of the first article into the cavity.
Example Ex24: The first article according to example Ex23, wherein the first article is configured such that the transferable flux concentrator and the first article do not interact mechanically with each other when the first article is inserted into the cavity.
Example Ex25: The first article according to any one of examples Ex23 or Ex24, wherein the first article comprises at least one recess, in particular at least one distal recess for receiving the transferable flux concentrator or at least parts of the transferable flux concentrator therein, such that the transferable flux concentrator is, preferably remains, in the first configuration upon insertion of the first article into the cavity.
Example Ex26: The first article according to any one of examples Ex23 to Ex25, wherein the first article comprises a liquid reservoir for storing a liquid aerosol-forming substrate therein.
Example Ex27: The first article according to example Ex26, wherein the liquid reservoir contains a liquid aerosol-forming substrate.
Example Ex28: An aerosol-generating device for alternative use with at least a first inductively heatable aerosol-generating article and a second inductively heatable aerosol-generating article, in particular a first and second aerosol-generating article according to the present invention and as defined herein, the first article comprising a susceptor of a first type for heating a first aerosol-forming substrate contained in the first article, the second article comprising a susceptor of a second type for heating a second aerosol-forming substrate contained in the second article, the aerosol-generating device comprising an induction heating module according to any one of the preceding examples or an induction heating module according to any one of examples Ex37 to Ex43.
Example Ex29: An aerosol-generating system comprising an aerosol-generating device according to example Ex28, at least one first inductively heatable aerosol-generating article, in particular at least one first inductively heatable aerosol-generating article according to any one of examples Ex23 to Ex27, and at least one second inductively heatable aerosol-generating article, the first article comprising a susceptor of a first type for heating a first aerosol-forming substrate contained in the first article, the second article comprising a susceptor of a second type for heating a second aerosol-forming substrate contained in the second article.
Example Ex30: The aerosol-generating system according to example Ex29, wherein the transferable flux concentrator and the first article are configured such that the transferable flux concentrator is, preferably remains, in the first configuration upon insertion of the first article into the cavity.
Example Ex31: The aerosol-generating system according to any one of example Ex29 or example Ex30, wherein the transferable flux concentrator and the first article are configured such that the transferable flux concentrator and the first article do not interact mechanically with each other when the first article is inserted into the cavity.
Example Ex32: The aerosol-generating system according to any one of examples Ex29 to Ex31, wherein the first article comprises at least one recess, in particular at least one distal recess for receiving the transferable flux concentrator or at least parts of the transferable flux concentrator therein, such that the transferable flux concentrator is, preferably remains, in the first configuration upon insertion of the first article into the cavity.
Example Ex33: The aerosol-generating system according to any one of examples Ex29 to Ex32, wherein the first article comprises a liquid reservoir containing a liquid aerosol-forming substrate.
Example Ex34: The aerosol-generating system according to any one of examples Ex29 to Ex33, wherein the second article is configured such as to interact mechanically with the transferable flux concentrator or at least parts thereof when the second article is inserted into the cavity, thereby transferring the transferable flux concentrator from the first configuration into the second configuration.
Example Ex35: The aerosol-generating system according to any one of examples Ex29 to Ex34, wherein the second article comprises a contact surface at a distal end of the article configured to contact the transferable flux concentrator or at least parts of the transferable flux concentrator when inserting the second article into the cavity, thus enabling to transfer the transferable flux concentrator from the first configuration into the second configuration when further inserting the second article into the cavity.
Example Ex36: The aerosol-generating system according to any one of examples Ex29 to Ex35, wherein the second article comprises a solid aerosol-forming substrate.
Example Ex37: The induction heating module according to any one of examples Ex1 to Ex22, wherein the transferable flux concentrator is transferable between the first configuration and the second configuration to modify the concentration of the alternating magnetic field of the induction coil between being concentrated in the first region within the cavity when the transferable flux concentrator is in the first configuration and being concentrated in the second region within the cavity when the transferable flux concentrator is in the second configuration, wherein said modification of the concentration of the alternating magnetic field of the induction coil results from the transfer of the transferable flux concentrator between the first configuration and the second configuration without a change in the position of the induction coil relative to the cavity (e.g., said modification of the concentration of the alternating magnetic field of the induction coil results entirely from the transfer of the transferable flux concentrator between the first configuration and the second configuration).
Example Ex38: The induction heating module according to any one of examples Ex1 to Ex22 or example Ex37, wherein the induction coil is a stationary induction coil.
Example Ex39: The induction coil according to any one of examples Ex1 to Ex22, or example Ex37, wherein the induction coil is fixedly arranged relative to the cavity.
Example Ex40: The induction coil according to any one of examples Ex1 to Ex22, or any one of examples Ex37 to Ex39, wherein the transferable flux concentrator is movable relative to the induction coil.
Example Ex41: The induction coil according to any one of examples Ex1 to Ex22, or any one of examples Ex37 to Ex40, wherein the transferable flux concentrator is transferable between the first configuration and the second configuration by being displaceable between a first position (e.g., a first position corresponding to the first configuration) and a second position (e.g., a second position corresponding to the second configuration).
Example Ex42: The induction coil according to example Ex41 wherein the transferable flux concentrator is transferable between the first configuration and the second configuration by being displaceable relative to the induction coil between the first position and the second position.
Example Ex43: The induction coil according to example Ex41 or example Ex42 wherein the transferable flux concentrator is transferable between the first configuration and the second configuration by being displaceable relative to the induction coil between the first position and the second position to thereby modify the concentration of the alternating magnetic field of the induction coil between being concentrated in the first region within the cavity when the transferable flux concentrator is in the first position and being concentrated in the second region within the cavity when the transferable flux concentrator is in the second position.
Example Ex44: The aerosol-generating system according to any one of examples Ex35 or Ex36 wherein the transferable flux concentrator is transferable between the first configuration and the second configuration by being displaceable (e.g., relative to the induction coil) between the first position and the second position, wherein the second article comprises a contact surface at a distal end of the article configured to contact the transferable flux concentrator or at least parts of the transferable flux concentrator when inserting the second article into the cavity, thus enabling to displace the transferable flux concentrator (e.g., relative to the induction coil) from the first position into the second position when further inserting the second article into the cavity.

Examples will now be further described with reference to the figures in which:

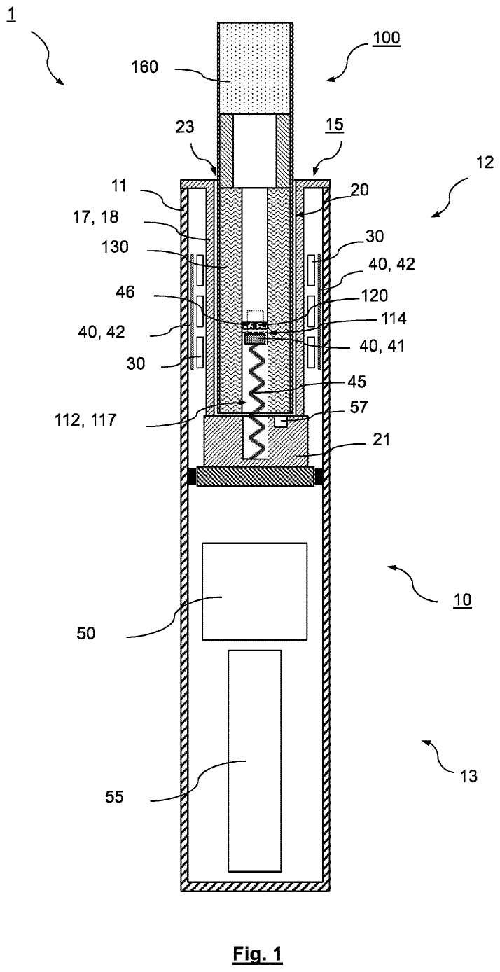

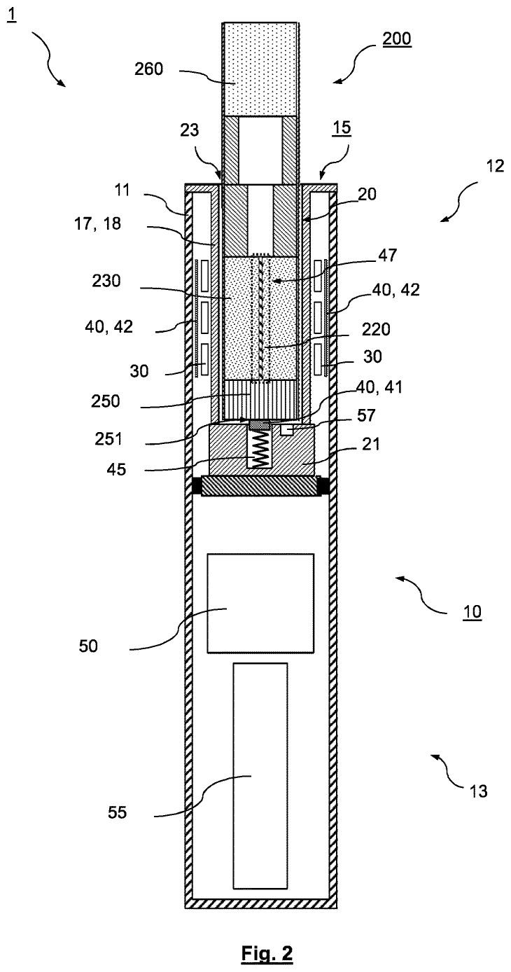

FIGS. 1-2 shows an exemplary embodiment of an aerosol-generating system according to the present invention;

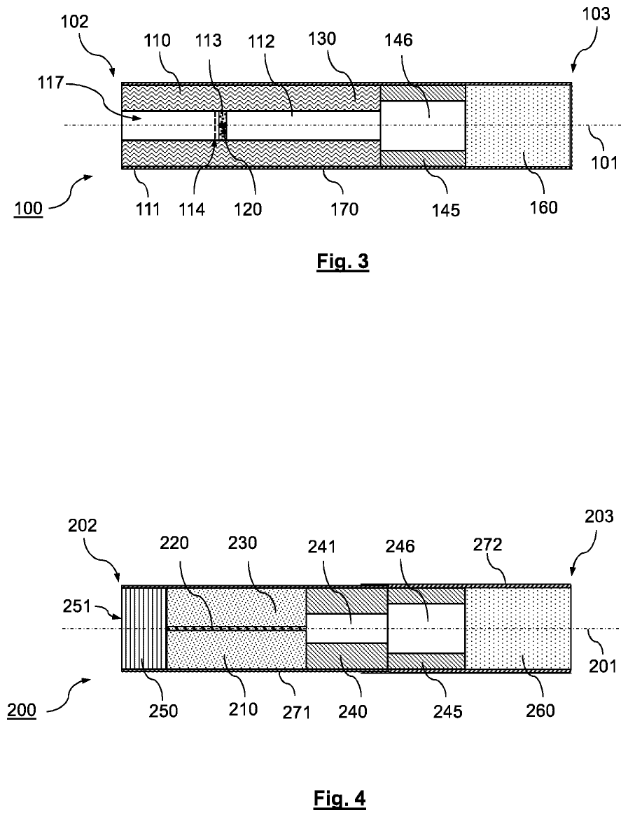

FIG. 3 shows the first aerosol-generating article of the system according to FIGS. 1-2; and

FIG. 4 shows the second aerosol-generating article of the system according to FIGS. 1-2.

FIG. 1 and FIG. 2 schematically illustrates an exemplary embodiment of an aerosol-generating system 1 according to the present invention (not to scale). The system 1 comprises at least three components: a first inductively heatable aerosol-generating article 100 (article of a first type), a second inductively heatable aerosol-generating article 200 (article of a second type) as well as an aerosol-generating device 10 for alternative use with the first article 100 and the second article 200. The aerosol-generating device 10 is capable to generate an inhalable aerosol in combination with each of the first and the second articles 100, 200 by inductively heating a respective susceptor 120, 220 in the first and the second article 100, 200 which is in thermal contact with a respective aerosol-forming substrate 130, 230 contained in the first and the second article respectively. Details of the first article 100 and the second article 200 are shown in FIG. 3 and FIG. 4, respectively.

With reference to FIG. 2 and FIG. 4, the second article 200 is a substantially rod-shaped consumable comprising five elements sequentially arranged in coaxial alignment: a distal front plug element 250, a substrate element 210, a first tube element 240, a second tube element 245, and a filter element 260. The distal front plug element 250 is arranged at a distal end 202 of the article 200 to cover and protect the distal front end of the substrate element 210, whereas the filter element 260 is arranged at a proximal end 203 of the article 200. Both, the distal front plug element 250 and the filter element 260 may be made of the same filter material. The filter element 260 preferably serves as a mouthpiece, especially as part of a mouthpiece together with the second tube element 245. The filter element 260 may have a length of 10 millimeter to 14 millimeter, for example, 12 millimeter, and the distal front plug element 250 may have a length of 3 millimeter to 6 millimeter, for example, 5 millimeter. Each one of the first and the second tube element 240, 245 is a hollow cellulose acetate tube having a central air passage 241, 246, wherein a cross-section of the central air passage 246 of the second tube element 245 is larger than a cross-section of the central air passage 241 of the first tube element 240. The first and second tube elements 240, 245 may have a length of 6 millimeter to 10 millimeter, for example, 8 millimeters. The substrate element 210 comprises a second, solid aerosol-forming substrate 230 that is capable of releasing volatile compounds upon heating, as well as a susceptor of a second type 220 for heating the substrate 230. In the present invention, the susceptor of the second type 220 is in an elongate susceptor strip made of metal, for example stainless steel, that is centrally embedded within the second aerosol-forming substrate 230. Thus, when heating the susceptor strip, the substrate 230 releases volatile compounds that can form an aerosol. As can be seen from FIG. 4, the susceptor strip is aligned substantially parallel to a length axis 201 of the second article 200, extending along the entire length of the substrate element 210. The susceptor strip has a length extension (along the length axis 201) of about 12 millimeter, a width dimension of about 4 millimeter, and a thickness dimension of about 50 micrometer. Each of the aforementioned elements 250, 210, 240, 245, 260 may be substantially cylindrical. In particular, all elements 250, 210, 240, 245, 260 may have the same outer cross-sectional shape and dimensions. In addition, the elements may be circumscribed by one or more outer wrappers such as to keep the elements together and to maintain the desired cross-sectional shape of the rod-shaped article 200. In the present embodiment, the distal front plug element 250, the substrate element 210 and the first tube element 240 are circumscribed by a first wrapper 271, whereas the second tube element 245 and the filter element 260 are circumscribed by a second wrapper 272. The second wrapper 272 also circumscribes at least a portion of the first tube element 240 (after being wrapped by the first wrapper 271) to connect the distal front plug element 250, the substrate element 210 and the first tube element 240 being circumscribed by the first wrapper 271 to the second tube element 245 and the filter element 260. Preferably, the first and the second wrapper 271, 272 are made of paper. In addition, the second wrapper 272 may comprise perforations around its circumference (not shown). The wrappers 271, 272 may further comprise adhesive that adheres the overlapped free ends of the wrappers to each other. In use, when a user takes a puff at the filter element 260, air is drawn into the first article 200 at its distal end 202 and continues to flow past the susceptor 220. There, volatile compounds released from the heated substrate 230 in use are entrained into the airflow. Subsequently, while flowing further downstream through the first and second tube elements 240, 245 towards the mouthpiece 260, the airflow including the volatilized material cools down to form an aerosol escaping the second article 200 at its proximal end 203.

Contrary to the second article 200 comprising a solid substrate 230, the first article 100 contains a first aerosol-forming substrate 130 that is liquid. Although different with respect to the substrate, the first article 100 has an outer shape and outer dimensions substantially identical to the second article 200 as can be seen from a comparison of FIG. 3 with FIG. 4. That is, the first article 100 is also a substantially rod-shaped consumable resembling the shape of a conventional cigarette. For storing the aerosol-forming liquid 130, the first article 100 comprises a liquid reservoir 110 formed by a hollow cylindrical cartridge 111 that is closed at both axial ends. The cartridge element 111 defines a distal portion of the first article 100. A liquid-conveying element 113, for example a cylindrical element made of porous ceramic, is arranged across the cylindrical inner void 112 of the hollow cartridge 111 to provide a capillary fluid communication for the liquid substrate 130 from the liquid reservoir 110 to a small susceptor of a first type 120. In the present embodiment, the susceptor of the first type 120 is a susceptor mesh made of metal that is circumferentially wrapped around a portion of the liquid-conveying element 113 within the cylindrical inner void 112 of the hollow cartridge 111. Thus, when heating the susceptor of the first type 120, aerosol-forming liquid 130 provided by the liquid-conveying element 113 may be volatilized to escape into the inner void 112 of the hollow cartridge 111. The susceptor mesh 120 has a (length) dimension of about 5 millimeter as measured in a direction along the length axis 101 of the first article 100, and a lateral dimension of about 2 millimeter as measured in a direction parallel to the length extension of the liquid-conveying element 113. Proximal to the cartridge element 111, the first article 100 comprises a tube element 145 with a central air passage 146 and a filter element 160. Preferably, the tube element 145 and the filter element 160 serve as mouthpiece defining a proximal portion of the first article 100. Each of the aforementioned elements 111, 145, 160 have a substantially cylindrical shape with about the same outer cross-sectional shape and dimensions. Similar to the second article 200, the elements 111, 145, 160 of the first article 100 are circumscribed by an outer wrapper 170 such as to keep the elements together. In use, when a user takes a puff at the filter element 160, air is drawn into the inner void 112 of the hollow cartridge 111 at the distal end 102 of the first article 100 and continues to flow past the susceptor mesh 120. There, material vaporized from the aerosol-forming liquid in use is entrained into the airflow through the inner void 112. Subsequently, while flowing further downstream through the tube element 145 towards the mouthpiece 160, the airflow including the vaporized material cools down to form an aerosol escaping the first article 100 at its proximal end 103.

Heating of the respective susceptors 120, 220 within the first and second article 100, 200 is accomplished by interaction with an alternating magnetic field provided by the aerosol-generating device 10. For this, a distal portion of the first article 100 (see FIG. 1) or the second article 200 (see FIG. 2) can be received in a cylindrical cavity 20 defined within a proximal portion 12 of the device 10. There, the alternating magnetic field used for heating the respective susceptors 120, 220 is generated by an inductive heating arrangement including an induction coil 30. In the present embodiment, the induction coil 30 is a helical coil made of three turns of a flat coil wire which circumferentially surrounds the cylindrical cavity 20. The induction coil 30 may be fixedly arranged relative to the cavity 20. The induction coil 30 may be a stationary induction coil.

Within a distal portion 13, the aerosol-generating device 10 further comprises a DC power supply 55 and a controller 50 (only schematically illustrated) for powering and controlling the heating process. Apart from the induction coil 30, the inductive heating arrangement preferably is at least partially integral part of the controller 50. The aerosol-generating device 10 according to the present embodiment further comprises a puff detector 57 for detecting a user's puff. The puff detector 57 is operatively connected to the controller 50 such that the detection of the occurrence of a puff by means of the puff detector 57 triggers the power delivery to the induction coil 30 for generating the alternating magnetic field. To this extent, the aerosol-generating device 10 may be denoted as a puff-on-demand device. The puff detector 57 and/or triggering of the power delivery to the induction coil 30 may be active or inactive depending on the type of the article currently received in the cavity 20. In the present embodiment, the puff detector 57 and/or triggering of the power delivery to the induction coil 30 may be active, when a first article 100 containing the liquid substrate 130 is received in the cavity 20, and inactive, when a second article 200 containing the solid substrate 230 is received in the cavity 20.

As can be further seen from FIG. 1 and FIG. 2, the induction coil 30 is surrounded by a tubular flux concentrator 42 which extends along the entire axial length of the induction coil 30 and is fixedly arranged relative thereto. That is, the flux concentrator 42 is stationary. In the present embodiment, the flux concentrator 42 is a flux concentrator foil comprising a material having a high magnetic permeability. At hand, the flux concentrator foil comprises a nano-crystalline soft magnetic alloy, for example a Vitroperm® alloy available as an adhesive-backed ribbon from VACUUMSCHMELZE GmbH & Co. KG, Germany in various thicknesses and widths. As illustrated in FIG. 1 and FIG. 2, the stationary flux concentrator 42 completely circumscribes the cylindrical induction coil 30 and the cavity 20 along at their entire axial length extension having a radial extension (thickness in radial direction) of about 50 micrometer. This can be achieved by wrapping one or more turns of the flux concentrator foil in one or more layers around the periphery of the cylindrical induction coil 30, depending on the actual thickness and width of the foil material. Basically, the flux concentrator 42 acts as a magnetic shield in order to reduce undesired heating of or interference with external objects. In addition, the stationary flux concentrator 42 causes the magnetic field lines generated by the induction coil 30 to be concentrate within the interior space of the cavity 20 so that the density of the magnetic field within the cavity 20 is increased. Thus, in combination with the cylindrical shape of the helical induction coil 30, the alternating magnetic field in the cavity 20 is substantially homogeneous, with magnetic field lines running substantially in parallel to the length axis of the cavity 20.

The axial length of the induction coil 30 and the stationary flux concentrator 42 are chosen such that is corresponds to the axial length and the axial position of the susceptor of the second type 220 when the second article 200 is received in the cavity 20. That is, the induction coil 30 and the stationary flux concentrator 42 are designed to have the alternating magnetic field of the induction coil 30 substantially concentrated a (second) region 47 within the cavity 20 (schematically illustrated by dotted rectangular in FIG. 2 [not to scale]) which is associated with the dimensions and the cavity position of the elongate, strip-like shape of the susceptor of the second type 220.

As follows from a comparison of FIG. 1 and FIG. 3 with FIG. 2 and FIG. 4, the dimensions and the cavity position of the more compact susceptor of the first type 120 in the first article 100 significantly differs from the dimensions and the cavity position of the elongate, strip-like shape of the susceptor of the second type 220 in the second article 200. Although the field distribution across the rather elongate second region 47 used for heating the susceptor of the second type 220 would also work in principle to heat the more compact susceptor of the first type 120 when a first article 100 is received in the cavity 20, the field density may still be too low in order enable the device 10 to instantaneously heat the liquid substrate 130 on a puff by puff basis (puff on demand). According to the invention it has been found that heating performance of the universal aerosol-generating device 10 can made be adaptable to the specific requirements of various article types by implementing a transferable flux concentrator 41 that is capable of modifying the properties of the magnetic field generated by the induction coil 30 within the cavity 20 depending on which type of article 100, 200 is received in the cavity 20, in particular such that the magnetic field is concentrated to a respective region 46, 47 within the cavity 20 which is occupied by the respective susceptor 120, 220 when a first or a second article 100, 200 is received in the cavity 20.

As illustrated in FIG. 1 and FIG. 2, the transferable flux concentrator 41 according to the present embodiment comprises a cylindrical solid flux concentrator body containing a ferrite powder having a high relative magnetic permeability that is held in a binder. As this material is rather brittle, the solid flux concentrator body is coated by a bond layer. Advantageously, the bond layer has good shock-absorbing properties and also serves as a support layer which keeps possible fragments of the transferable flux concentrator 41 bonded in the event of breakage into fragments. Preferably, the bond layer is a polymeric bond layer comprising a vapor deposited poly(p-xylylene) polymers, for example a parylene.

The transferable flux concentrator 41 is attached to one end of a helical spring 45 the other end of which is attached to a distal end wall 21 of the cavity 20. The spring 45 biases the transferable flux concentrator 41 in a direction towards the insertion opening 23 of the cavity 20, but allows to move the transferable flux concentrator 41 in the opposite direction along a linear trajectory parallel to the length axis of the cavity 20 towards the distal end of the cavity by compression of the spring 45.

As can be further seen from FIG. 1, the dimensions of the transferable flux concentrator 41 are chosen such that it can be received in a distal recess 117 of the first article 100 that is formed by the open-ended distal end section of the inner void 112 of the hollow cartridge 111. Thus, during insertion of the first article 100 into the cavity 20, the transferable flux concentrator 41 and the first article 100 do not interact mechanically with each other. When the first article 100 is about to reach and finally has reached its pre-defined final position in the cavity 20, the transferable flux concentrator 41 may interact mechanically with the first article 100 by abutting against a stop element 114 arranged in the inner void 112 of the hollow cartridge 111 which defines a bottom surface of the distal recess 117. The stop element 114 is perforated allowed flow a to the inner void 112 of the hollow cartridge 111. When the first article 100 has reached its pre-defined final position in the cavity 20, the bottom surface of the distal recess 117 defines the first configuration—here: first position—of the transferable flux concentrator 41. In this position (see FIG. 1), the transferable flux concentrator 41 modifies the alternating magnetic field as provided by the induction coil 30 and shaped by the stationary flux concentrator 42 to concentrate the alternating magnetic field into the above described first region 46 that is associated with the dimensions and the position of the susceptor of the first type 120 in the cavity 20 (see FIG. 1). As a result, the field intensity is locally enhanced in the first region 46, which enables the device 10 to heat the susceptor of the second type 220 more efficiently and thus to instantaneously heat the liquid substrate 130 on a puff by puff basis (puff on demand).

However, the field modifying effect of the transferable flux concentrator 41 is only required if a first article 100 is to be heated. If a second article 200 is to be heated, the transferable flux concentrator 41 should not affect the field distribution as given by the dimensions and positions of the induction coil 30 and the stationary flux concentrator 42 as it already matches the dimensions and the cavity position of the susceptor of the second type 200. For this, the transferable flux concentrator 41 is transferable from the first position into a second configuration—here: second position—close to the distal end of the cavity 20. In the second position, the transferable flux concentrator 41 is located completely outside and axially far enough offset from the induction coil 30 and thus has basically no effect on the magnetic field of the induction coil 30. That is, in the second position, the alternating magnetic field within the interior space of the induction coil 30 is spread over the elongate first region 47 (see FIG. 2) as determined by the dimensions and positions of the induction coil 30 and the stationary flux concentrator 42.

In the present embodiment, transfer of the transferable flux concentrator 41 from the first configuration into the second configuration is automatically accomplished by insertion of the second article 200 into the cavity without the user having to take any additional action. For this, the transferable flux concentrator 41 mechanically interacts with the second article 200 when being inserted into the cavity 20 in the distal direction by abutting against the distal end surface of the distal front plug element 250 which provides a contact surface 251 such that the flux concentrator 41 is transferred from the first configuration to the second configuration. Vice versa, the transferable flux concentrator 41 is automatically returned from the second configuration towards the first configuration when the second article 200 is removed from the cavity 20 in the proximal direction, again without the user having to take any additional action.

In the example illustrated in FIGS. 1-2, when the transferable flux concentrator 41 mechanically interacts with the second article 200 when the second article 200 is being inserted into the cavity 20 in the distal direction by abutting against the distal end surface of the distal front plug element 250 of the second article 200 which provides a contact surface 251 such that the transferable flux concentrator 41 is transferred from the first configuration to the second configuration, the transferable flux concentrator 41 moves relative to the (e.g., stationary) induction coil 30 from the first position to the second position to thereby modify the concentration of the alternating magnetic field of the induction coil 30 between being concentrated in the first region 46 within the cavity 20 when the transferable flux concentrator 41 is in the first position and being concentrated in the second region 47 within the cavity 20 when the transferable flux concentrator 41 is in the second position. The modification of the concentration of the alternating magnetic field of the induction coil 30 results from the transfer of the transferable flux concentrator 41 from the first configuration to the second configuration without a change in the position of the induction coil 30 relative to the cavity 20. It may be that said modification of the concentration of the alternating magnetic field of the induction coil 30 results entirely from the transfer of the transferable flux concentrator 41 from the first configuration to the second configuration.

Together, the transferable flux concentrator 41 and the stationary flux concentrator 40 form a magnetic flux concentrator arrangement 40.

The magnetic flux concentrator arrangement 40 with the transferable flux concentrator 41 and the stationary flux concentrator 40, and the induction coil 30 may be part of an induction heating module 15. In addition to the aforementioned components, the induction heating module 15 may further comprise a coil support 17 arranged within the device housing 11 for supporting the induction coil 30. As shown in FIG. 1 and FIG. 2, the coil support 17 according to the present embodiment comprises a sleeve portion 18 the interior space of which defines the cavity 20 for receiving the first and the second article 100, 200.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±5% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An induction heating module for alternative use with at least a first inductively heatable aerosol-generating article and a second inductively heatable aerosol-generating article, the first inductively heatable aerosol-generating article being of a different type of inductively heatable aerosol-generating article from the second inductively heatable aerosol-generating article, the first inductively heatable aerosol-generating article comprising a susceptor of a first type configured to heat a first aerosol-forming substrate contained in the first inductively heatable aerosol-generating article, the second inductively heatable aerosol-generating article comprising a susceptor of a second type configured to heat a second aerosol-forming substrate contained in the second inductively heatable aerosol-generating article, the induction heating module comprising:
a cavity configured to removably receive at least a portion of the first or the second inductively heatable aerosol-generating article;
an induction coil configured to generate an alternating magnetic field to inductively heat the respective susceptor of the first inductively heatable aerosol-generating article or the second inductively heatable aerosol-generating article when being received in the cavity; and
a magnetic flux concentrator arrangement comprising a flux concentrator, which is transferable at least between a first configuration and a second configuration such that the alternating magnetic field of the induction coil is concentrated selectively in a first region or a second region within the cavity,
wherein the first region is associated with a dimension and/or a position of the susceptor of the first type in the cavity when the first inductively heatable aerosol-generating article is received in the cavity, and
wherein the second region is associated with a dimension and/or a position of the susceptor of the second type in the cavity when the second inductively heatable aerosol-generating article is received in the cavity.

17. The induction heating module according to claim 16, wherein the transferable flux concentrator is transferable from the first configuration to the second configuration by insertion of the second inductively heatable aerosol-generating article.

18. The induction heating module according to claim 16, wherein the transferable flux concentrator is transferable from the second configuration to or towards the first configuration by removal of the second inductively heatable aerosol-generating article from the cavity.

19. The induction heating module according to claim 16, wherein the magnetic flux concentrator arrangement further comprises a return mechanism configured and arranged to transfer the transferable flux concentrator from the second configuration towards or to the first configuration when the second inductively heatable aerosol-generating article is removed from the cavity.

20. The induction heating module according to claim 19, wherein the return mechanism is at least one spring biasing the transferable flux concentrator towards or into the first configuration.

21. The induction heating module according to claim 16, wherein the transferable flux concentrator comprises a solid flux concentrator body.

22. The induction heating module according to claim 16, wherein the transferable flux concentrator comprises a ferromagnetic material.

23. The induction heating module according to claim 16, wherein the transferable flux concentrator comprises a ferromagnetic stainless steel.

24. The induction heating module according to claim 16, wherein the transferable flux concentrator is coated at least partially by a bond layer.

25. The induction heating module according to claim 16, wherein the magnetic flux concentrator arrangement further comprises a stationary flux concentrator.

26. The induction heating module according to claim 16, wherein the stationary flux concentrator is arranged around the induction coil.

27. The induction heating module according to claim 16, wherein the induction coil is a stationary induction coil.

28. A first inductively heatable aerosol-generating article for the induction heating module according to claim 16, the first inductively heatable aerosol-generating article comprising a susceptor of a first type and being configured such that the transferable flux concentrator is in the first configuration upon insertion of the first inductively heatable aerosol-generating article into the cavity, wherein the first inductively heatable aerosol-generating article comprises at least one recess configured to receive the transferable flux concentrator or at least parts of the transferable flux concentrator therein, such that the transferable flux concentrator is in the first configuration upon insertion of the first inductively heatable aerosol-generating article into the cavity.

29. The first inductively heatable aerosol-generating article according to claim 28, wherein the at least one recess is at least one distal recess.

30. An aerosol-generating device for alternative use with at least a first inductively heatable aerosol-generating article and a second inductively heatable aerosol-generating article, the first inductively heatable aerosol-generating article comprising a susceptor of a first type for heating a first aerosol-forming substrate contained in the first inductively heatable aerosol-generating article, the second inductively heatable aerosol-generating article comprising a susceptor of a second type for heating a second aerosol-forming substrate contained in the second inductively heatable aerosol-generating article, the aerosol-generating device comprising the induction heating module according to claim 16.

31. An aerosol-generating system comprising the aerosol-generating device according to claim 30, at least one first inductively heatable aerosol-generating article, and at least one second inductively heatable aerosol-generating article, the first inductively heatable aerosol-generating article comprising a susceptor of a first type configured to heat a first aerosol-forming substrate contained in the first inductively heatable aerosol-generating article, the second inductively heatable aerosol-generating article comprising a susceptor of a second type configured to heat a second aerosol-forming substrate contained in the second inductively heatable aerosol-generating article.

32. The aerosol-generating system according to claim 31, wherein the first aerosol-forming substrate is a liquid aerosol-forming substrate contained in a liquid reservoir.

33. The aerosol-generating system according to claim 32, wherein the second inductively heatable aerosol-generating article is configured such as to interact mechanically with the transferable flux concentrator or at least parts thereof when the second inductively heatable aerosol-generating article is inserted into the cavity, thereby transferring the transferable flux concentrator from the first configuration into the second configuration.

34. The aerosol-generating system according to claim 32, wherein the second inductively heatable aerosol-generating article further comprises a contact surface at a distal end of the article configured to contact the transferable flux concentrator or at least parts of the transferable flux concentrator when inserting the second inductively heatable aerosol-generating article into the cavity, thus allowing the transferable flux concentrator to transfer from the first configuration into the second configuration when further inserting the second inductively heatable aerosol-generating article into the cavity.
